(19) United States
(12) Patent Application Publication
(10) Pub. No.: US 2022/0142197 A1
(43) Pub. Date: May 12, 2022

(54) FONDANT PRESS

(71) Applicant: Daniel Peter Conway, Mooroolbark (AU)

(72) Inventor: Daniel Peter Conway, Mooroolbark (AU)

(21) Appl. No.: 17/522,274

(22) Filed: Nov. 9, 2021

(30) Foreign Application Priority Data
Nov. 10, 2020 (AU) 2020904096

(51) Int. Cl. A23G 3/02; A23P 30/00; B30B 9/28

(52) U.S. Cl. CPC A23G 3/0242; B30B 9/28; A23P 30/00

(57) ABSTRACT

A fondant press 10 for aiding food preparation comprises a first fabiform shaped side portion 16 and a second fabiform shaped side portion 17 which are angled relative to each other such that a planar lower surface 12 of the fondant press 10 is wider than a planar upper surface 11 of the fondant press 10; the upper and lower surfaces 11, 12 of the fondant press 10 have flanged rims 30, 31 which extend around the circumference of the side portions 16, 17 and are integrally formed with a first end portion 13 and a second end portion 14 of the fondant press 10 defining a pair of curved handles 20, 21 in the upper surface 11 of the end portions 13, 14; the lower surface 12 has a recess 15 formed within it for receiving a stamp.

### CROSS-REFERENCE TO RELATED APPLICATION

This application claims priority to Australian provisional application no. 2020904096, filed Nov. 10, 2020, entitled FONDANT PRESS.

### TECHNICAL FIELD

The present invention relates to presses, rollers and other apparatus for aiding or facilitating food preparation, particularly, for baking or cooking.

### BACKGROUND ART

The following discussion of the background art is intended to facilitate an understanding of the present invention only. The discussion is not an acknowledgment or admission that any of the material referred to is or was part of the common general knowledge as at the priority date of the application.

Food preparation in industrial or professional kitchens can be labour intensive and hard upon the bodies of those involved. Repetitive tasks over time can lead to repetitive strain injuries. Improvements in food preparation techniques including the incorporation of task specific implements or apparatus can greatly enhance the time and ease whereby cooks and bakers can achieve their desired results and can also result in greater profitability of commercial kitchens.

Bakers traditionally roll fondant over a cookie or biscuit stamp to obtain an impression in the fondant icing or topping. Alternatively, the stamp would be impressed directly into rolled fondant by hand in order to create the impression. Over the course of the last year or so, bakers have incorporated the use of pop stamps to create impressions in fondant toppings which they have prepared. This technique has enjoyed widespread adoption in that time. Problems arise with the use of pop stamps due to the inherent characteristics of traditional rolling pins which make it difficult to ensure that an evenly rolled impression is made in the fondant. Further using traditional rolling pins with pop stamps increases the risk of repetitive strain injury occurring which until now has not been an issue. There is presently no task specific apparatus available for this purpose and the inventor has identified a means whereby the above problems may be alleviated.

The problem with both of these afore described traditional methods is that the force being applied to make the impression in the fondant is unnatural and therefore is often applied unevenly creating an imperfect impression. Rolling pins provide even pressure but cause strain in the wrists because of the pressure required to roll it over the fondant and stamp evenly (in an outwardly motion). When hand pressing a stamp into fondant by hand, the force is cumbersome and often is not adequate to achieve an even enough or depressed enough image.

The present invention seeks to overcome, or at least ameliorate, one or more of the deficiencies of the prior art mentioned above, or to provide the consumer with a useful or commercial choice.

Each document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness.

Reference to fondant press throughout this specification will be deemed to apply to any apparatus which may be used or employed for pressing or rolling stamped images into food stuffs.

Throughout this specification, unless the context requires otherwise, the word “comprise” or variations such as “comprises” or “comprising”, will be understood to imply the inclusion of a stated integer or group of integers but not the exclusion of any other integer or group of integers

### SUMMARY OF INVENTION

In accordance with the present invention there is provided a fondant press for aiding food preparation comprising:

a first fabiform shaped side portion and a second fabiform shaped side portion which are angled relative to each other such that a planar lower surface of the fondant press is wider than a planar upper surface of the fondant press;

the upper and lower surfaces of the fondant press have flanged rims which extend around the circumference of the side portions and are integrally formed with a first end portion and a second end portion of the fondant press defining a pair of curved handles in the upper surface of the end portions;

the lower surface has a recess formed within it for receiving a stamp.

Preferably the recess formed in the lower surface is curved and substantially follows the radial curve of the lower surface to ensure the application of even downward pressure upon a stamp when in use.

Preferably the end portions of the fondant press are displaced from each other at approximately the chest width of a fondant press operator.

In some embodiments of the present invention one or more of the side portions is detachable from the fabiform planar member to expose an internal cavity.

In other embodiments of the invention the internal cavity has a plurality of perpendicular structural support members integrally formed with the internal surface of the cavity to provide structural support.

In especially preferred embodiments the upper surface of the fondant press overhangs the side portions forming a ridge along the circumference of the fondant press in order to enhance the operator's grip upon the handles.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a side view of the fondant press.

FIG. 2 is a perspective view of the fondant press with one or both of the side portions detached.

FIG. 3 is a perspective view of the fondant press.

FIG. 4 is an end view of one of the end portions indicating the off-set angles of the side portions.

FIG. 5 is a rear view of the fondant press.

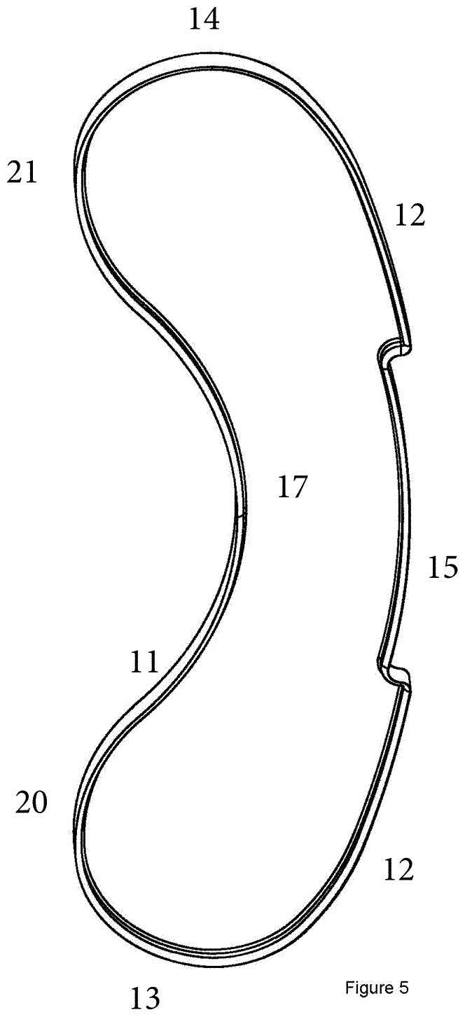

### DESCRIPTION OF EMBODIMENTS

The fondant press of the present invention is primarily used for creating an embossed or debossed image into fondant in partnership with a ‘cookie stamp’ or ‘pop stamp’. The fondant press replaces a traditional rolling pin or hand forced impressions for this process.

The fondant press has been designed to make baker's work easier and with lower risk of developing repetitive strain injuries (“RSI”). The inventive design and functionality enabled by the present invention increases the speed at which tasks can be completed which maximises the use of available time and in turn increases output and profits from labour.

Bakers traditionally roll fondant over a cookie or biscuit stamp in order to obtain an impression in the fondant icing or topping. Before now, the fondant would be impressed directly into rolled fondant by hand or the fondant would be rolled out evenly with a traditional rolling pin over the stamp, in turn creating the impression.

The inventor has determined that there is no specific apparatus available to meet that purpose efficiently and effectively. Existing apparatus used by bakers and other food preparation specialists typically use apparatus such as rolling pins which are particularly hard on the wrists, are not designed for high volume use with pop stamps or cookie stamps and carry the risk of the user developing RSI. The use of pop stamps to make impressions in fondant has only been adopted widely relatively recently ie. 12 months or so, and so the problem of rolling impressions in fondant evenly and without joint strain wasn't previously an issue.

The problem with these traditional methods is that the force exerted by the operator is unnatural and therefore is often unevenly applied. Rolling pins provide even pressure but cause strain in the wrists because of the pressure required to roll it over the fondant and stamp evenly (in an outwardly motion). When hand pressing a stamp into fondant by hand, the force is cumbersome and often not adequate to achieve an even enough or depressed enough image.

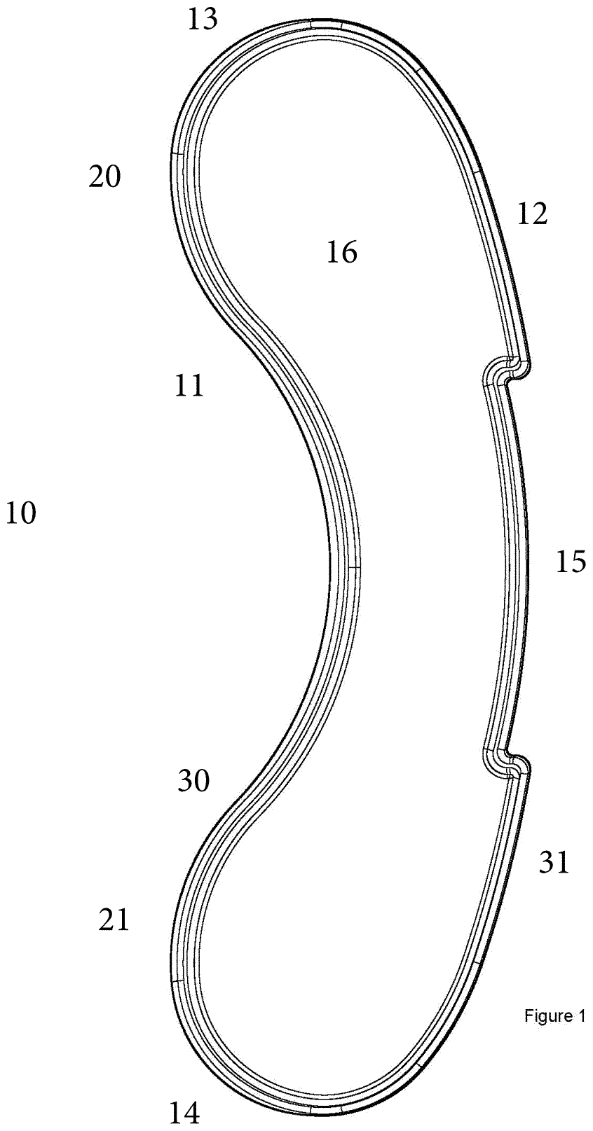

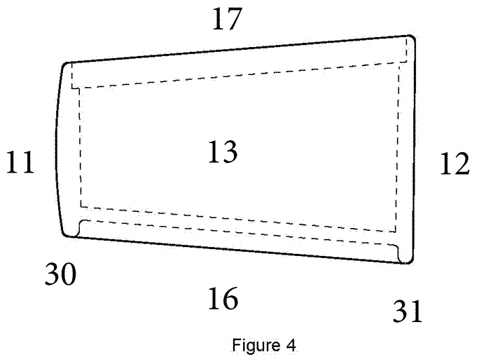

As shown in FIG. 1, the fondant press 10 of the present invention has a first fabiform shaped side portion 16 and a second fabiform shaped side portion 17 which are angled relative to each other, as indicated in FIG. 4, such that a planar lower surface 12 of the fondant press is wider than a planar upper surface 11 of the fondant press. The upper and lower surfaces 11, 12 of the fondant press have flanged rims 30, 31 which extend around the circumference of the side portions and are integrally formed with a first end portion 13 and a second end portion 14 of the fondant press 10 defining a pair of curved handles 20, 21 in the upper surface 11 of the end portions 13, 14. The lower surface 12 has a recess 15 formed within it for receiving a stamp (not shown).

The recess 15 formed in the lower surface 12 is curved and substantially follows the radial curve of the lower surface 12 to ensure the application of even downward pressure upon a stamp when in use.

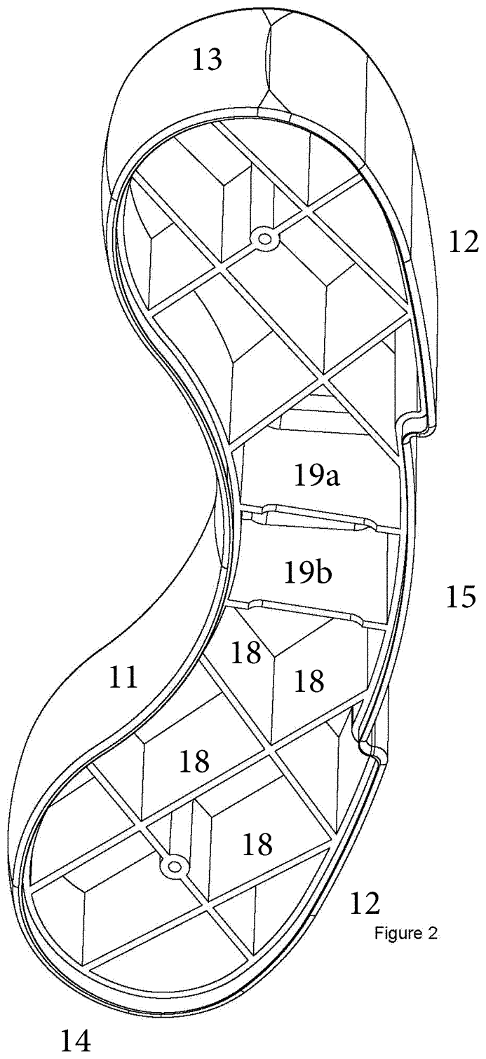

FIG. 2 displays the fondant press 10 with side portion 16 removed to show a plurality of perpendicularly displaced internal support members 18 located within an internal cavity of the fondant press 10 at the handle portions 20, 21 for providing structural support to the handle portions 20, 21 of the fondant press 10.

Located within the internal cavity above the recess 15 formed within the lower surface 12 of the fondant press are a pair of substantially parallel support walls 19a, 19b for providing reinforcement and structural support against the downward force of the fondant press operator when impressing a stamp contained within the recess 15 upon fondant and the opposing force of the stamp when located upon a hard surface.

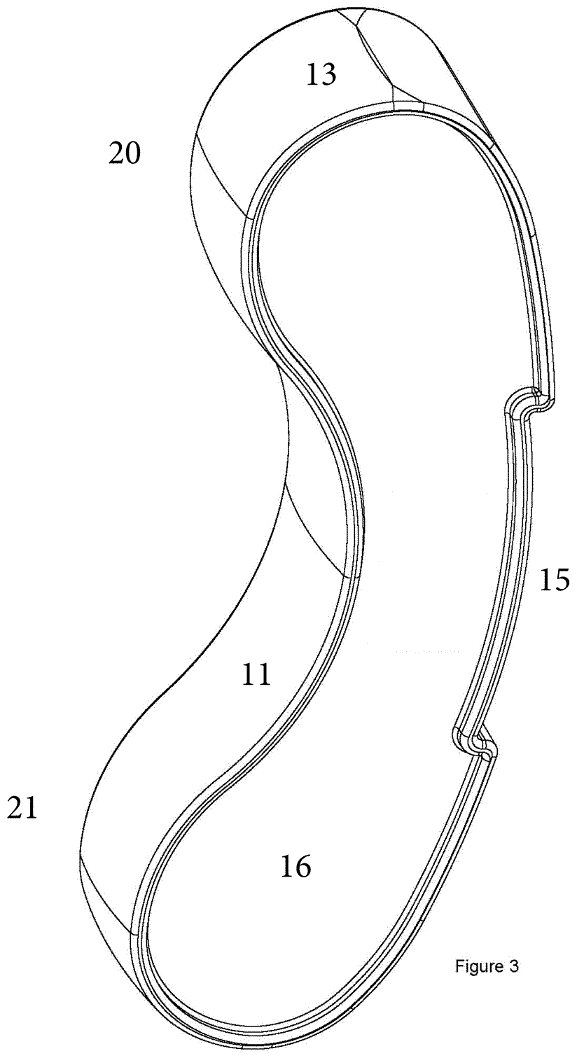

As shown in FIG. 3, the handles 20, 21 of the fondant press 10 are displaced from each other at approximately chest width of the operator in order to ensure a smooth and even downward force can be exerted by the operator when the fondant press 10 is in use.

The fondant press of the present invention solves both traditional problems by using a natural rocking motion of the press onto a stamp which in turn creates an even and well impressed image into the fondant, while using the operator's natural body weight (in a downward motion instead of an outward motion) to facilitate that outcome. Because the operator is leaning over the tool in a natural position instead of applying pressure outwards in an unnatural position, as with a rolling pin, there is no to little strain for the operator when using the fondant press.

The curved handle portions 20, 21 assist the baker to apply even pressure across the stencil using body weight, the central indented portion or recess 15 for receiving the stencil or stamp ensures that even pressure is applied as the operator “rocks” the handle portions 20, 21 from side to side.

The handles 20, 21 spaced at or about chest width of the operator are designed to provide excellent gripping whilst maximising the user's torso weight for even impression from stamp to fondant. The upper and lower surfaces 11, 12 of the fondant press have a circumferential flange 30, 31 for aiding the grip of the operator. The width of the fondant press allows for maximum leverage with minimum effort by the operator. The curved recess 15 in the lower surface 12 of the fondant press 10 allows for the insertion of a stamp and enables the operator to apply an even downward pressure or force as he or she “rocks” across the fondant with the fondant press 10. The curved recess 15 formed within or on the lower surface 12 allows for cookie stamps and pop stamps of any size to fit within the recess 15 in order to press the stamp into fondant or dough in a smooth rocking motion.

The fondant press 10 of the present invention reduces ongoing health problems associated with an operator developing RSI from using inadequately designed apparatus, permits faster output of product and therefore greater profit. The fondant press 10 can also be adapted for use in other food preparation tasks including by way of non-limiting example, crushing nuts and other foods, rolling/flattening dough and pastry, impressing dough and pastry and other foodstuffs. The fondant press 10 is lightweight and easy to use, easy to clean as it is ideally manufactured from food grade non-stick plastic and is more hygienic to use that traditional methods as there is less human contact with food stuffs.

The fondant press 10 is preferably manufactured of high density, non-stick food grade plastic although could be manufactured out of any suitable material for example, glass, timber, stainless steel or ceramic by way of non-limiting examples. The shape of the fondant press 10 can also be readily modified to suit a plethora of operator's requirements and for use with different foodstuffs and culinary tasks.

Modifications and variations such as would be apparent to the skilled addressee are considered to fall within the scope of the present invention.

1. A fondant press for aiding food preparation comprising:
a first fabiform shaped side portion and a second fabiform shaped side portion which are angled relative to each other such that a planar lower surface of the fondant press is wider than a planar upper surface of the fondant press;
the upper and lower surfaces of the fondant press have flanged rims which extend around the circumference of the side portions and are integrally formed with a first end portion and a second end portion of the fondant press defining a pair of curved handles in the upper surface of the end portions;
the lower surface has a recess formed within it for receiving a stamp.

2. The fondant press of claim 1, wherein the recess formed in the lower surface is curved and substantially follows the radial curve of the lower surface to ensure the application of even downward pressure upon a stamp when in use.

3. The fondant press of claim 1 wherein the end portions of the fondant press are displaced from each other at approximately the chest width of a fondant press operator.

4. The fondant press of claim 2, wherein the end portions of the fondant press are displaced from each other at approximately the chest width of a fondant press operator.

5. The fondant press of claim 1, wherein one or more of the side portions is detachable from the fondant press to expose an internal cavity.

6. The fondant press of claim 2, wherein one or more of the side portions is detachable from the fondant press to expose an internal cavity.

7. The fondant press of claim 3, wherein one or more of the side portions is detachable from the fondant press to expose an internal cavity.

8. The fondant press of claim 4, wherein one or more of the side portions is detachable from the fondant press to expose an internal cavity.

9. The fondant press of claim 5, wherein the internal cavity has a plurality of perpendicular structural support members integrally formed with the internal surface of the cavity to provide structural support.

10. The fondant press of claim 6, wherein the internal cavity has a plurality of perpendicular structural support members integrally formed with the internal surface of the cavity to provide structural support.

11. The fondant press of claim 7, wherein the internal cavity has a plurality of perpendicular structural support members integrally formed with the internal surface of the cavity to provide structural support.

12. The fondant press of claim 8, wherein the internal cavity has a plurality of perpendicular structural support members integrally formed with the internal surface of the cavity to provide structural support.

13. The fondant press of claim 1, wherein the upper surface of the fondant press overhangs the side portions forming a ridge along the circumference of the fondant press in order to enhance the operator's grip upon the handles.

14. The fondant press of claim 2, wherein the upper surface of the fondant press overhangs the side portions forming a ridge along the circumference of the fondant press in order to enhance the operator's grip upon the handles.

15. The fondant press of claim 3, wherein the upper surface of the fondant press overhangs the side portions forming a ridge along the circumference of the fondant press in order to enhance the operator's grip upon the handles.

16. The fondant press of claim 4, wherein the upper surface of the fondant press overhangs the side portions forming a ridge along the circumference of the fondant press in order to enhance the operator's grip upon the handles.

17. The fondant press of claim 5, wherein the upper surface of the fondant press overhangs the side portions forming a ridge along the circumference of the fondant press in order to enhance the operator's grip upon the handles.

18. The fondant press of claim 6, wherein the upper surface of the fondant press overhangs the side portions forming a ridge along the circumference of the fondant press in order to enhance the operator's grip upon the handles.

19. The fondant press of claim 7, wherein the upper surface of the fondant press overhangs the side portions forming a ridge along the circumference of the fondant press in order to enhance the operator's grip upon the handles.

20. The fondant press of claim 9, wherein the upper surface of the fondant press overhangs the side portions forming a ridge along the circumference of the fondant press in order to enhance the operator's grip upon the handles.
